(19) United States
(12) Patent Application Publication
(10) Pub. No.: US 2008/0128493 A1
(43) Pub. Date: Jun. 5, 2008

(54) Laser Marking of Pigment Layers on Documents

(76) Inventors: Robert L. Jones, Andover, MA (US); Daoshen Bi, Boxborough, MA (US)

Correspondence Address: DIGIMARC CORPORATION, 9405 SW GEMINI DRIVE, BEAVERTON, OR, 97008, US

(21) Appl. No.: 11/849,168

(22) Filed: Aug. 31, 2007

Related U.S. Application Data
(60) Provisional application No. 60/824,410, filed on Sep. 1, 2006.

(51) Int. Cl. G06K 5/00; B23K 26/00; B44F 1/06

(52) U.S. Cl. 235/380; 219/121.85; 428/29

(57) ABSTRACT

A laser markable document material comprises a binder sensitive to laser energy, a pigment interspersed in the binder, and a document substrate. One example of the pigment is a pearlescent silicate, which has optically varying effects. The binder is applied to the document substrate using a form of printing or other means of applying a coating. This coating provides a first indicia of fixed or variable information, such as the seal of the document issuer or personal information of a document bearer. A laser engraver writes a second indicia into the coating.

### RELATED APPLICATION DATA

This application claims the benefit of U.S. Provisional Patent Application No. 60/824,410, filed Sep. 1, 2006, which is hereby incorporated by reference.

### TECHNICAL FIELD

### Background and Summary

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening and prior to boarding their flight. In addition, because we live in an ever-evolving cashless society, ID documents are used to make payments, access an automated teller machine (ATM), debit an account, or make a payment, etc.

(For the purposes of this disclosure, ID documents are broadly defined herein, and include, e.g., credit cards, bank cards, phone cards, passports, driver's licenses, network access cards, employee badges, debit cards, security cards, smart cards (e.g., cards that include one more semiconductor chips, such as memory devices, microprocessors, and microcontrollers), contact cards, contactless cards, proximity cards (e.g., radio frequency (RFID) cards), visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.).

Many types of identification cards and documents, such as driving licenses, national or government identification cards, bank cards, credit cards, controlled access cards and smart cards, carry certain items of information which relate to the identity of the bearer. Examples of such information include name, address, birth date, signature and photographic image; the cards or documents may in addition carry other variable data (i.e., data specific to a particular card or document, for example an employee number) and invariant data (i.e., data common to a large number of cards, for example the name of an employer). All of the cards described above will be generically referred to as “ID documents”.

FIGS. 1 and 2 illustrate a front view and cross-sectional view (taken along the A-A line), respectively, of an identification (ID) document 10. In FIG. 1, the ID document 10 includes a photographic image 12, a bar code 14 (which may contain information specific to the person whose image appears in photographic image 12 and/or information that is the same from ID document to ID document), variable personal information 16, such as an address, signature, and/or birthdate, and biometric information 18 associated with the person whose image appears in photographic image 12 (e.g., a fingerprint, a facial image or template, or iris or retinal template), a magnetic stripe (which, for example, can be on a side of the ID document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

Referring to FIG. 2, the ID document 10 comprises a pre-printed core 20 (also referred to as a substrate). In many applications, the core can be a light-colored, opaque material (e.g., a filled polyolefin substrate (like TESLIN® substrate, a silica filled polyolefin printing substrate available from PPG Industries), polyvinyl chloride (PVC) material, polyester, polycarbonate, etc.). The core 20 is laminated with a transparent material, such as clear PVC or polyester material 22, which, by way of example, can be about 1-5 mil thick. The composite of the core 20 and clear laminate material 22 form a so-called “card blank” 25 that can be up to about 30 mils thick. Information 26a-c is printed on the card blank 25 using a method such as Laser Xerography, laser engraving, offset press, ink jet or Dye Diffusion Thermal Transfer (“D2T2”) printing (e.g., as described in commonly assigned U.S. Pat. No. 6,066,594, which is incorporated hereto by reference in its entirety.) The information 26a-c can, for example, comprise variable information (e.g., bearer information) and an indicium or indicia, such as the invariant or nonvarying information common to a large number of identification documents, for example the name and logo of the organization issuing the documents. The information 26a-c may be formed by any known process capable of forming the indicium on the specific core material used.

To protect the information that is printed, an additional layer of transparent overlaminate 24 can be coupled to the card blank and printed information. Illustrative examples of usable materials for overlaminates include biaxially oriented polyester or other optically clear durable plastic film.

“Laminate” and “overlaminate” include, but are not limited to film and sheet products. Laminates used in documents include substantially transparent polymers. Examples of laminates used in documents include polyester, polycarbonate, polystyrene, cellulose ester, polyolefin, polysulfone, and polyamide. Laminates can be made using either an amorphous or biaxially oriented polymer. The laminate can comprise a plurality of separate laminate layers, for example a boundary layer and/or a film layer.

The degree of transparency of the laminate can, for example, be dictated by the information contained within the identification document, the particular colors and/or security features used, etc. The thickness of the laminate layers can vary and is typically about 1-20 mils. Lamination of any laminate layer(s) to any other layer of material (e.g., a core layer) can be accomplished using a lamination process.

In ID documents, a laminate can provide a protective covering for the printed substrates and provides a level of protection against unauthorized tampering (e.g., a laminate would have to be removed to alter the printed information and then subsequently replaced after the alteration.). Various lamination processes are disclosed in assignee's U.S. Pat. Nos. 5,783,024, 6,007,660, 6,066,594, and 6,159,327. Other lamination processes are disclosed, e.g., in U.S. Pat. Nos. 6,283,188 and 6,003,581. A co-extruded lamination technology described in this document also appears in U.S. Patent Application Publication No. 2005-0084693. Each of these U.S. patents and applications is herein incorporated by reference.

The material(s) from which a laminate is made may be transparent, but need not be. Laminates can include synthetic resin-impregnated or coated base materials composed of successive layers of material, bonded together via heat, pressure, and/or adhesive. Laminates also includes security laminates, such as a transparent laminate material with proprietary security technology features and processes, which protects documents of value from counterfeiting, data alteration, photo substitution, duplication (including color photocopying), and simulation by use of materials and technologies that are commonly available. Laminates also can include thermosetting materials, such as epoxy.

In a typical ID document, one or more laminate layers are joined together with the substrate, possibly including other security devices, such as holograms, integrated circuits, optical memory, RFID tag, etc. to form a complete document. These laminate layers are designed to enhance the durability and security of the identification documents. From the standpoint of durability, the laminate should increase the document's ability to withstand wear and tear experienced in the field, including heat and humidity that can compromise the integrity of the document structure.

Laser marking and specifically, laser engraving, is used in some forms of photo identification documents to print variable images. While laser engraving offers some advantages in terms of security from counterfeiting, there is an ever present demand to develop more sophisticated, yet cost effective security features for value documents. One way to improve security is to use multiple layers of security features, each making the counterfeiting task more difficult. Preferably, the security features are physically and/or logically linked together through a relationship of data in the features so that tampering with the document will break this linkage.

One aspect of the invention is a laser markable document material comprising a binder sensitive to laser energy, a pigment interspersed in the binder, and a document substrate. One example of the pigment is a pearlescent silicate, which has optically varying effects. The binder is applied to the document substrate using a form of printing or other means of applying a coating. This coating provides a first indicia of fixed or variable information, such as the seal of the document issuer or personal information of a document bearer. A laser engraver writes a second indicia into the coating.

Additional aspects of the invention include methods of marking a document, including applying a coating with the pigment and laser engraving it. Other aspects of the invention include methods for authenticating documents having such markings.

Additional aspects of the invention include ID documents and methods for making the ID documents and parts of ID documents. The aspects of the invention are not intended to be limited to those specifically mentioned here, but instead, are intended to encompass various methods, document structures, compositions and articles comprising combinations of the teachings within this document.

### BRIEF DESCRIPTION OF THE DRAWINGS

The advantages, features, and aspects of embodiments of the invention will be more fully understood in conjunction with the following detailed description and accompanying drawings, wherein:

FIG. 1 is an illustrative example of an identification document;

FIG. 2 is an illustrative cross section of the identification document of FIG. 1, taken along the A-A line;

FIG. 3 is a diagram illustrating a cross section of an identification document including a laser markable coating between laminate and core layers that provides a variable and personalizable security feature;

FIG. 4 is a diagram illustrating an example of an identification document with a variable security feature over a photo of the document's bearer.

FIG. 5 is a flow diagram illustrating a method for applying a laser sensitizing coating and then laser engraving that coating.

FIG. 6 is a flow diagram illustrating alternative methods for marking indicia on laser sensitized areas of a document.

FIG. 7 is a flow diagram illustrating a method for authenticating a document with interlocking security elements including variable laser engraved information.

Of course, the drawings are not necessarily drawn to scale, with emphasis rather being placed upon illustrating the principles of the invention. In the drawings, like reference numbers indicate like elements or steps. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION

For purposes of illustration, the following description will proceed with reference to ID document structures (e.g., filled polyolefin-core or Polycarbonate-core, multi-layered ID documents). It should be appreciated, however, that the invention is not so limited. Indeed, as those skilled in the art will appreciate, the inventive techniques can be applied to many other structures formed in many different ways.

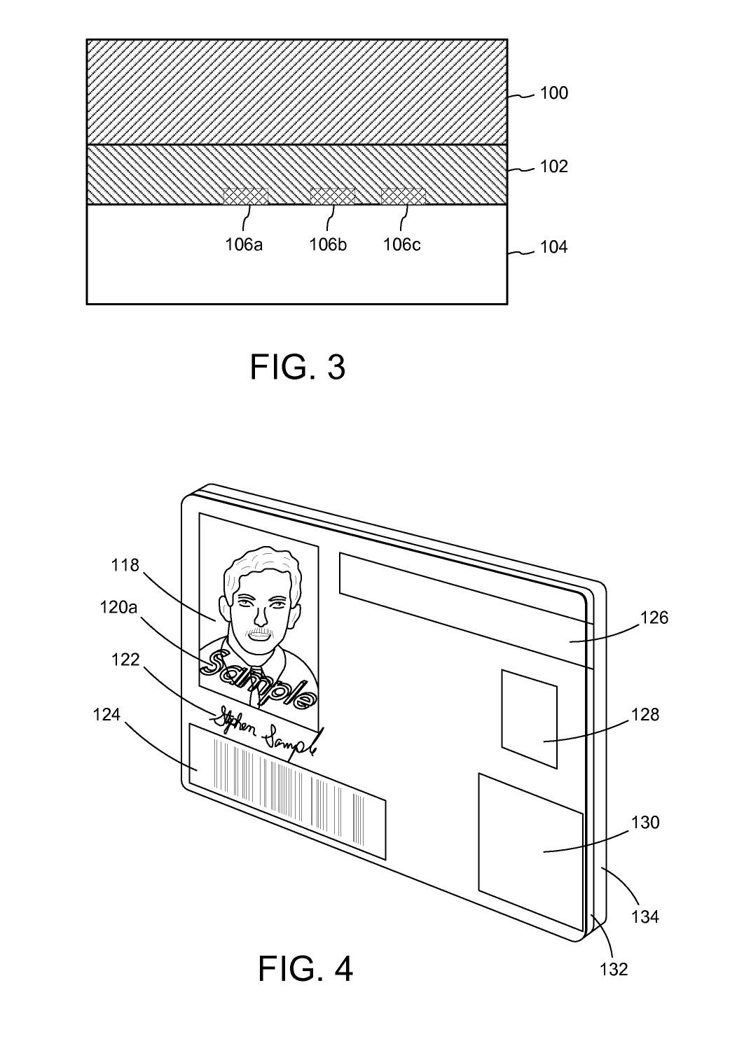

FIG. 3 is a diagram illustrating a cross section of an identification document including a carrier layer 106a-c between laminate 100, 102 and core layers 104 creating a variable security feature. The carrier layer is comprised of a pigment mixed into a polymer binder or other carrier material. The pigment is chosen to have desired optical properties, including a color shifting effect. In one category of embodiments, the pigment is comprised of particles that have an oblong shape, causing them to align in a substantially common orientation. In one particular embodiment in this class, the pigment comprises silicate particles that have a pearlescent quality. These particles provide an optically variable effect achieved when viewed at different viewing angles. Particles are chosen to have the desired optical effects. Namely, they are chosen to have the desired color and optically varying effects, such as providing desired color and fluorescing in selected bands (visible, V, IR) when illuminated with light in corresponding illumination bands (visible, UV, IR) and illuminated and viewed at particular angles.

Suitable pigments for this application include mica based pearlescent pigments, borosilicate based pearlescent pigments, and metallic based ink. The particle sizes vary from 2 to 60 microns. Fine particle pigments produce fine image qualities. Examples of some of the pigments and suppliers are listed in table below.

| Pigments | Supplier |
|---|---|
| DUOCHROME 224C (red-gold) | Engelhard |
| FLAMENCO GOLD 220C | Engelhard |
| AFFLAIR 103 (silver) | EMD |
| | Chemicals |
| EM's AFFLAIR 7235 (GREEN) | EMD |
| | Chemicals |
| Colorstream T10-03 | EMD |
| | Chemicals |
| Colorstream T10-01 | EMD |
| | Chemicals |
| AFFLAIR 7215 (RED) | EM Industries |
| AFFLAIR 7225 (BLUE) | EM Industries |
| Phoenix PX 1261 | Eckart |
| | America |
| DUOCHROME 622C (Mearl) | Engelhard |
| Mearlin Micro Gold 9260M | Engelhard |
| Mearlin Gold 9220 | Engelhard |
| MagnaPearl 3000 | Engelhard |

The carrier comprises a polymer resin selected to carbonize in response to laser engraving. In one class of embodiments, the carrier comprises polyester and/or polycarbonate resin that is particularly chosen to be sensitive to laser light so that it carbonizes when that light energy is applied. In another embodiment, the carrier comprises hydroxypropylcellulose (e.g., a Klucel® binder for the pigment).

To laser engrave the coating in our ID card manufacturing process, we use a YAG near infrared laser engraver (e.g., 1060 nm Nd: YAG laser).

In this particular example, the carrier layer 106a-c partially overlaps areas of a core layer 104 that have been pre-printed with information (e.g., Xerographic printing of fixed or variable information). A laminate layer, which itself in this case, comprises two layers 100, 102 is applied to the core layer over the pre-printed information and the coating 106a-c.

To further demonstrate this feature, FIG. 4 is a diagram illustrating examples of where the coating of pigment is applied over various areas of an ID document. The ID document of FIG. 4 includes information pre-printed on the core layer, such as the bearer's photo 118, bearer's signature 122, a bar code 124. In addition, it may include other printed elements such as biometric image (e.g., fingerprint) 126, ghost image 128, and personal information of the bearer 130 such as name, DL number, date of birth, address, etc.

In this example, the binder and pigment mixture is printed using an offset press. In some areas, a block of the mixture is printed at desired screen level (e.g., a block of 50-75% screen) to provide a uniform area that may then be laser engraved with personalized information such a photo of the bearer, a fingerprint image, retinal image, etc. Alternatively, a gravure process is applied to coat the mixture over a portion of the core layer's surface. One particular approach is to print a first indicia with the mixture in a line screen, e.g., a 2400-3600 DPI printing of line structure elements, each around 1 MIL in thickness. Portions of these areas are then laser engraved, causing selective carbonization of the binder that forms a second indicia. For example, a 300 DPI laser engraver applies laser energy to the pre-printed fine line structures, selectively marking the binder in these structures at a 300 DPI resolution to form a laser marked indicia. One example of printing of the pigment in the binder mixture is personalized printing (e.g., bearer's name “sample” 120a) over the bearer's photo image 118. Other examples include printing blocks of the binder mixture in the areas of the barcode 124, biometric image 126, ghost image 128, personalized information 130, or other areas, such as background regions or in printing a pattern of fixed information such as the issuer's seal.

After printing the binder and pigment material, this material is laser engraved with fixed or variable information. Examples of fixed information include information common to a batch of documents from an issuer, such as a seal or lot number. Examples of variable information include personalized information of the bearer, such as name, signature, date of birth, fingerprint image, facial photo, biometric template, etc. For example, a laser engraved pattern of interlocking text is printed in the bearer's name, “sample” overlaying the photo. A facial image of the bearer is laser engraved in a block of the coating printed in the background. A fingerprint image is laser engraved in a block of the coating printed in the background or fingerprint area. A digital watermark signal is laser engraved in the pre-printed background, barcode image, ghost image, or other area. As demonstrated by these examples, the laser engraving provides a means to interlock elements of information on the document logically and physically. Logical interlocking is achieved by recording common or mathematically related information in the same or different areas on the document, allowing verification by a correlation of the common data in these areas and/or checking for pre-established relationships among the information, such as verifying that data in one feature matches a secure hash of the data in another feature. Physical interlocking is achieved by using the laser engraving to mark a second indicia in the first indicia represented in the pre-printed coating. The laser engraving of the text of the bearer's name into other printed personal information such as text of the bearer's name or demographic information, bearer's photo, bearer's biometric template, etc. Another example is laser engraving fixed or variable information into the first indicia representing the issuer's seal.

After marking the core layer, a laminate is applied over it. An example of a suitable laminate structure for use in this embodiment is a co-extruded laminate formed from two different polyester layers 100, 102. Additional polymer layers may also be included. A first laminate layer 100 forms the outer surface of the document structure. It comprises a first polyester material selected for its durability. In particular, a durable polyester material is selected that is highly chemically and mechanically resistant. One example of a polyester material with these properties is A150 PCTA material from Eastman Chemical. This particular polyester is one of the most durable, and is found to be chemically and mechanically resistant.

A150 Copolyester from Eastman is a poly(1,4-cyclohexylene-dimethylene terephthalate/isophthalate). It is produced by reacting terephthalic acid and isophthalic acid with the glycol 1,4-cyclohexanedimethanol.

A second laminate layer 102 of a different polyester material forms an inner surface of the laminate and has bonding properties for bonding the composite laminate structure directly to a filled polyolefin or polyester core 104. Examples of this second material include PETG 5011 or PETG 6763 from Eastman Chemical. PET refers to polyethylene terephthalate. PETG is also known as glycolised polyester, and the “G” represents glycol modifiers.

Copolyester 5011 from Eastman Chemical is a glycol modified polyethylene terephthalate (PET). The modification is made by adding a second glycol, cyclohexanedimethanol (CHDM) during the polymerization stages. The second glycol is added in the proper proportion to produce an amorphous polymer.

Copolyester 6763 from Eastman Chemical is a clear, amorphous material. Because of its clarity, toughness and good melt strength at processing temperatures, it is useful in a variety of processing techniques including film and sheet extrusion.

Both of these PETG polyesters bond well to a TESLIN core layer and act as an adhesive layer in this construction. Together, the different polyester materials form a composite laminate layer. This laminate layer is then bonded to the front and/or back of the core layer in the ID document. The ratio of A150 to 6763 or 5011 can be altered to optimize the performance.

The manufacturing process for making this type of composite laminate starts with the two different polyester materials that are melted to form two melt streams. Both melt streams are brought together in a planar orientation and cooled to form a single laminate at the exit of the machine.

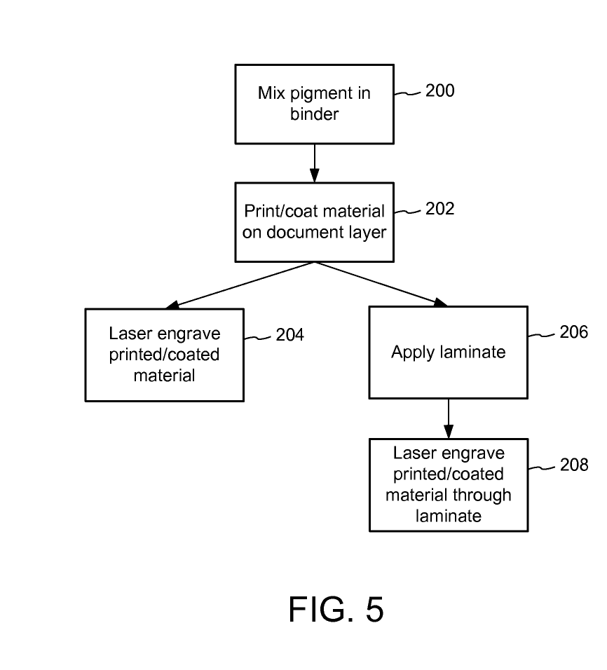

FIG. 5 is a flow diagram illustrating a method for applying the laser sensitized pigment coating and then laser engraving that coating. The process begins by mixing the pigment particles into the binder (200). Separately, a first layer of variable and/or fixed information on the core using a printing process, such as Xerographic printing or alternative method (e.g., liquid ink printing, ink jet, mass transfer, etc.). This printing process applies variable information of the document bearer, such as a facial image, name, address, birth date, and document number (Driver's License Number). This printing process may also apply fixed information to the core associated with the document issuer, such as a state graphic, logo, or seal.

In the context of central issue processing, the core is typically in the form of a sheet material, and different documents are printed on the sheet of core material as it moves through a first stage of printing. In central issue manufacturing, personal information from applicants is obtained at an enrollment site (e.g., a DMV site for driver's license issuance), and sent to a central issue manufacturing facility, where it is queued for printing on sheets of core material.

For over the counter issuance, the core may also be pre-printed with information. However, the card stock is manufactured prior to enrollment, and is personalized at the time of enrollment in an “over the counter” enrollment process, where personal information is obtained and then printed on individual cards in an over the counter card printer.

Returning to the process in FIG. 5, the core material with pre-printed information is passed to another stage (202). In this stage, the binder, acting as a carrier for the pigment, is applied by printing or other form of coating in one or more areas of the core layer, in the form of fixed or variable information, as described previously. This process forms a carrier layer.

Next, the carrier layer is laser engraved (204) with fixed or variable information as described above. In one embodiment, a near infrared YAG laser engraver is used to engrave the desired information into the carrier layer. It is also possible to laser engrave the carrier layer after one or more other layers are applied over it. One example, depicted in FIG. 5, is to apply a laminate, such as the co-extruded laminate 100, 102 or other laminate (206), and then laser engrave the carrier layer through the laminate (208). In this case, the laminate is selected so as to be relatively insensitive to the energy of the laser engraver in relation to the sensitivity of the carrier layer. This differential in sensitivity enables the document to marked after its manufacture of its multilayer structure.

In another variant of this process, a reflective coating, such as an aluminum based coating, is applied to the substrate prior to applying the carrier layer.

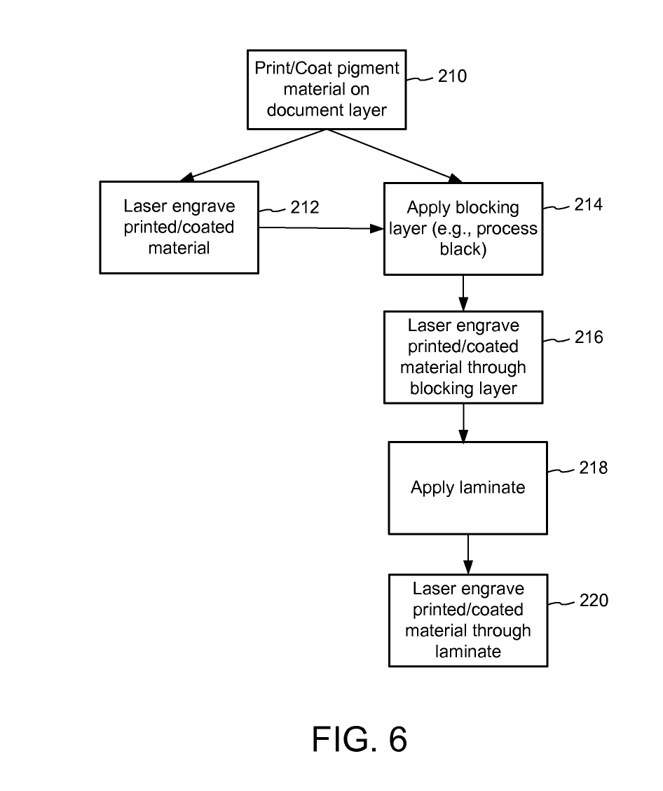

FIG. 6 illustrates further examples of laser engraving the document material at different stages of document production. As in FIG. 5, the document substrate is pre-processed by applying the carrier layer comprising a binder and pigment dispersed in it (210). Then, one option is to laser engrave the carrier layer (212). Alternatively, or in addition, a blocking layer is applied over the carrier layer (214). The blocking layer is chosen to block the carrier layer from human viewing in normal lighting, yet enable laser marking and image capture of the indicia marked in the carrier layer. One example is to print a layer of material in a process black color (e.g., print a block or stripe of black dye), which is substantially opaque to a human viewer in normal lighting, yet substantially transparent to non-visible energy (e.g., IR) used by the laser engraver for writing data and an illumination and capture device for capturing an image of the laser engraved indicia. After the blocking layer is applied, the carrier layer is laser engraved for a first or subsequent time (216) through the blocking layer. Next, the laminate layer is applied (218). Once again, the carrier layer is laser engraved for a first or subsequent time (220).

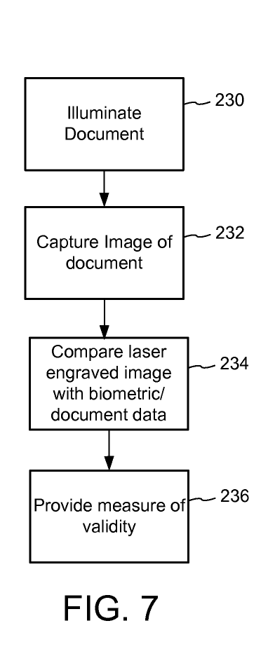

FIG. 7 is a flow diagram illustrating a method for authenticating a document with interlocking security elements including variable laser engraved information. First, the document is illuminated with light energy in an illumination band selected to be compatible with any blocking layer and optical property of the pigment in the laser engraved carrier layer (230). This illumination may involve pulsing the light source(s) in different energy bands for selected times and viewing angles corresponding to the optical properties of the laser engraved carrier layer to capture one or more images of the first indicia of the carrier as well one or more images of the laser engraved indicia (232). Next, the indicia of the laser engraved image is analyzed relative to other image or machine readable data on the document, including the first indicia, if any, depicted in the carrier layer (234). In addition, it may be analyzed relative to corresponding image data captured from the bearer at an access or check point or from data retrieved from a database. In one example embodiment, the laser engraved indicia is a facial photo, which is correlated with the photo of the bearer (e.g., 118, FIG. 4). In another example, the laser engraved indicia is a fingerprint image, which is correlated with the fingerprint of the bearer. In yet another example, the laser engraved indicia conveys a digital watermark signal. The digital watermark signal carriers information logically linked with information elsewhere on the document (e.g., in a machine readable carrier), in a database, or captured from the bearer at an access or check point. As noted, the logical relationship of data elements may be formed using a secure hash of information in one element and then encoding it in another, such as the digital watermark. Each of these forms of analysis provides a measure of validity, such as a correlation metric, hash comparison, etc. that together are aggregated into a composite measure of validity. One embodiment is implemented in a programmable device with a graphical user interface. This device provides a display depicting the results of the validity measures and indicates to an operator, which of the security elements is invalid. Of course, manual inspection of the images on the card or captured and displayed on the device provide further means for assessing the document's validity.

In one embodiment, a digital watermark signal is embedded in an image, such as a facial photo, which in turn, is laser engraved into the carrier layer. In another, the digital watermark signal is directly marked in a block of carrier material, which itself, overlays a pre-printed image. The digital watermark conveys a digital message payload. This message is error correction encoded and then randomly and repeatedly distributed over a two dimensional area to create the digital watermark signal. The digital watermark signal is then inserted into an image, which is then laser engraved onto the carrier, or it is directly laser written into the carrier layer. The digital watermarking processes of embedding and reading are detailed in U.S. Pat. No. 6,614,914, which is hereby incorporated by reference.

The use of the blocking layer enables the laser engraved indicia to act as a covert storage medium for bearer information, such as biometric information like a fingerprint or retinal scan. This storage medium obviates the need for other data carriers, such as RFID, smart cards, high density optical memory, etc., or in more expensive card systems, enhances the security of them by providing an additional means of interlocking elements of the card with each other, bearer information and database information.

The co-extruded laminate described in this document may be used as the laminate. This co-extruded laminate is applied with heat and pressure, but without an adhesive due to the bonding properties of the laminate with the core material. As such, the laminate is joined directly to the front and/or back of the core. A roll-to-roll or platen press can be used to join the surface of the laminate with bonding property to the core. To create a platen press version, A150 is replaced by a polymer that does not crystallize under conditions typically found in a platen press process or the press cycle is adjusted so that crystallization does not occur to a substantial level or degree.

In one embodiment for central issue, the co-extruded laminate described above is used for both top and bottom card lamina and a TESLIN core, preprinted with bearer information and photo using a Xerox Doc 12 xerographic printer. In this case, the document structure is laminated at interface temperatures in excess of 280 F at standard pressures and line speeds of ˜0.5 fpm at current configuration. Preprint patterns/coverage is limited around each card's perimeter to within a minimum of about 0.125″—thus ensuring an aggressive bond of the co-extruded laminate to the TESLIN core even at “intrusion” temperatures.

While the discussion above provides examples suitable for a central issue environment, where personalized information is available at the time of document manufacture, variations of the process may be used to create card stock used for over the counter issuance. For example, the coating may be applied to and cured on a pre-printed core (where the core is pre-printed with fixed information). One or more over-laminate layers and a D2T2 image receiver layer may be subsequently added over the cured material to enable the blank card to be printed with personal information at an over-the-counter issuance facility.

The embodiments detailed above are examples of how to mingle different polyester materials to achieve a synergistic effect that exceeds each material's properties. For example, A150 PCTA does not bond to a TESLIN core but is chemically and mechanically resistant, and 6763 and 5011 PETG bond well to the TESLIN core but are not as chemically or mechanically resistant.

The composite laminate structure is not limited to two layers, but instead, can be increased to additional layers, each contributing in durability and security.

While a coextrusion is illustrated, alternative processes may be used to join polyester layers into a composite laminate. These processes include roll-to-roll, extrusion coating, platen press, and injection/extrusion molding processes.

Other types of polymers may be used to create a coextruded laminate product as described above. The outer layer should have a durability property, such as properties that prevent cracking and/or aging. The inner layer forms a surface for bonding to a document layer, such as the core layer described above. It has a bonding property that facilitates direct bonding to the document layer. This inner layer is chemically related to/miscible with the laminate layer with which it is joined, e.g., by coextrusion to create the coextruded laminate. It is also chemically related to/miscible with the document layer to which it is joined as described. Bonding properties of the inner layer include, for example, its chemical relationship with the layer to which it is joined (e.g., they are miscible), its molar attraction to the layer to which it is joined, its degrees of melting and viscosity. For example, the inner bonding layer in the laminate has a different degree of melting and viscosity than the outer layer or layers providing durability that enable it to bond to the document layer to which the laminate is joined.

In the laminate structures described above, a laminate layer is selected that has a bonding property for bonding the laminate structure directly to document base materials without a separate adhesive layer. These document base materials include toners and inks printed on a TESLIN, polyester, copolyester, amorphous polyester, or like family substrates.

As illustrated above, co-extrusion methods may be used to join two or more laminate layers into the laminate structure before direct bonding to the base materials. Each of these laminate layers can contribute desired durability and bonding properties for direct bonding to a document's base materials without adhesive. In co-extrusion methods, a first laminate layer is co-extruded with one or more performance enhancing layers. In the example provided above, the carrier layer comprises a PCTA copolyester. This carrier provides durability performance while the enhancement layers (e.g., PETG, etc.) provide bonding performance that increase the security of the identification document by avoiding the need for an adhesive layer between the laminate and document base material. Other materials can be used as the carrier layer, and a material acting as a carrier in one embodiment may act as an enhancement layer in other embodiments.

A list of materials that may be combined with a carrier layer by co-extrusion to provide a bonding property that enhances bonding performance with base materials of inks, toners, and core TESLIN, polyester, copolyester, amorphous polyester, or like family substrates, includes, but is not limited to: SURLYN, mLDPE, EVA, EEA, and EMA.

A list of materials that provide a durability property for enhancing durability performance, either as a carrier or enhancement layer, include, but are not limited to: LDPE, HDPE, PP, and LLDPE. Members of this particular family can also be used as bonding layers coupled with one of the others in this family as the carrier.

### ADDITIONAL EXAMPLES

In one embodiment, screen printed pearlescent is directly imaged by an Nd:YAG laser on printing substrates, including plastics and in particular, a silica filled polyolefin substrate. The pearlescent pigment sensitizes plastic materials for laser engraving including polyethylene-acetate, polyester and co-extruded polyesters as above, and blended copolymers like polycarbonate and PET blends. A covert feature is created by applying a blocking layer, such as a stripe of black dye over the area to be laser marked. The laser marked image is then read through the blocking layer with an IR scanner.

This approach for laser marking pearlescent pigments is applied in a variety of document applications. One application is to laser engrave a high resolution image on an ID document representing the bearer's photo or other biometric imagery. With the addition of a blocking layer, the laser engraving is covert. Whether covert, visible and or optically varying, the laser engraving can be used to write a bar code or other optically readable data storage element. The formulations of the pigment and binder can be introduced into document layers to make them laser markable. For example, they may be co-extruded into a silica filled polyolefin substrate to make it laser markable. The laser marking becomes embedded in the core material, which enables the core material to be personalized and also provides a tamper evident feature. The laser marking provides tamper evidence in that the marking cannot be removed or separated from the substrate by removing the overlaminate because the laser marking remains in the surface of the core.

The example pigments described previously can be formulated into inks for gravure, screen or offset printing. The following are examples of each:

Gravure printing ink formulation:

| | |
|---|---|
| Ethyl Acetate | 31.25% wt |
| n-Propyl Acetate | 31.25% wt |
| Bostik 2700B LMW | 17.94% wt |
| Vitel 5833B | 1.56% wt |
| Afflair7235 | 18% wt |

Screen printing formulation:

| | |
|---|---|
| Mearlin Micro Gold 9260M | 25% |
| 9700 HTEX: | 75% |

Offset printing ink formulation:

| | |
|---|---|
| Pantone 877 Silver ink: | #46G8877 from Hostmann-Steinberg |
| Green pearl Tinted ink: | from Hostmann-Steinberg |

### Manufacture and Printing Environments

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

A CI assembling process is more of a bulk process facility, where many cards are produced in a centralized facility, one after another. (For example, picture a setting where a driver passes a driving test, but then receives her license in the mail from a CI facility a short time later. The CI facility may process thousands of cards in a continuous manner.).

Centrally issued identification documents can be produced from digitally stored information and generally comprise an opaque core material (also referred to as “substrate”), such as paper or plastic, sandwiched between two or more layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents.

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if large volumes of ID documents are manufactured.

U.S. patent application Ser. No. 10/325,434 (now U.S. Pat. No. 6,817,530), which is hereby incorporated by reference, describes approaches for manufacturing identification documents in a central issue process.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document. It will be appreciated that an OTC card issuing process is by its nature can be an intermittent—in comparison to a continuous—process.

OTC identification documents of the types mentioned above can take a number of forms, depending on cost and desired features. Some OTC ID documents comprise plasticized poly(vinyl chloride) or have a composite structure with polyester laminated to 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 .mu.m), or a clear polyester laminate (0.5-10 mil, 13-254 .mu.m) supporting common security features. These last two types of protective foil or laminate sometimes are applied at a laminating station separate from the printhead. The choice of laminate dictates the degree of durability and security imparted to the system in protecting the image and other data.

### Concluding Remarks

Having described and illustrated the principles of the technology with reference to specific implementations, it will be recognized that the technology can be implemented in many other, different, forms, and in many different environments.

The technology disclosed herein can be used in combination with other technologies. Also, instead of ID documents, the inventive techniques can be employed with product tags, product packaging, labels, business cards, bags, charts, smart cards, maps, labels, etc., etc. The term ID document is broadly defined herein to include these tags, maps, labels, packaging, cards, etc.

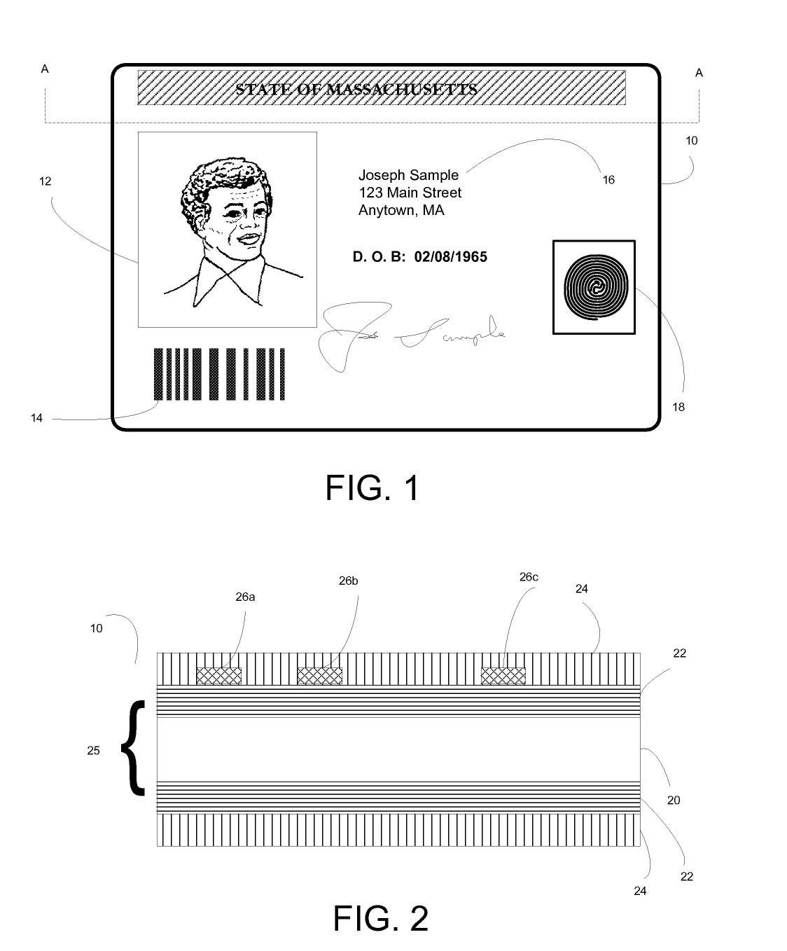

It should be appreciated that while FIG. 1 illustrates a particular species of ID document—a driver's license—the present invention is not so limited. Indeed our inventive methods and techniques apply generally to all identification documents defined above. Moreover, our techniques are applicable to non-ID documents. Further, instead of ID documents, the inventive techniques can be employed with product tags, product packaging, business cards, bags, charts, maps, labels, etc., etc. The term ID document is broadly defined herein to include these tags, labels, packaging, cards, etc.

It should be understood that various printing processes could be used to create the identification documents described in this document. It will be appreciated by those of ordinary skill in the art that several print technologies including but not limited to indigo (variable offset) laser xerography (variable printing), offset printing (fixed printing), inkjet (variable printing), dye infusion, mass-transfer, wax transfer, variable dot transfer, laser engraving can be used to print variable and/or fixed information on one or more layers of the document. The information can be printed using dots, lines or other structures of varying colors to form text or images. The information also can comprise process colors, spot or pantone colors.

It should be understood that, in the Figures of this application, in some instances, a plurality of method steps may be shown as illustrative of a particular method, and a single method step may be shown as illustrative of a plurality of a particular method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art will recognize that the number of a particular system element or method steps can, in some instances, be selected to accommodate the particular user needs.

To provide a comprehensive disclosure without unduly lengthening the specification, applicants hereby incorporate by reference each of the U.S. patent documents referenced above.

The technology and solutions disclosed herein have made use of elements and techniques known from the cited documents. Other elements and techniques from the cited documents can similarly be combined to yield further implementations within the scope of the present invention.

Thus, the exemplary embodiments are only selected samples of the solutions available by combining the teachings referenced above. The other solutions necessarily are not exhaustively described herein, but are fairly within the understanding of an artisan given the foregoing disclosure and familiarity with the cited art. The particular combinations of elements and features in the above-detailed embodiments are exemplary only; the interchanging and substitution of these teachings with other teachings in this and the incorporated-by-reference patent documents are also expressly contemplated.

In describing the embodiments of the invention illustrated in the figures, specific terminology is used for the sake of clarity. However, the invention is not limited to the specific terms so selected, and each specific term at least includes all technical and functional equivalents that operate in a similar manner to accomplish a similar purpose.

What is claimed is:

1. A laser markable document material comprising:
a binder sensitive to laser energy;
a pigment interspersed in the binder; and
a document substrate, the binder applied to the document substrate.

2. The material of claim 1 wherein the binder comprise a polymer that carbonizes in response to laser engraving.

3. The material of claim 2 wherein the laser engraving comprises carbonizing with a YAG laser.

4. The material of claim 2 wherein the pigment comprises a silicate pigment.

5. The material of claim 2 wherein the pigment comprises a pearlescent pigment.

6. The material of claim 2 wherein the pigment comprises an optically variable pigment, wherein the pigment comprises particles that have a structure causing the particles to align substantially along an orientation such that viewing information printed with this pigment shifts when viewed at different viewing angles.

7. The material of claim 1 wherein a blocking layer is applied over the binder, the blocking layer comprising a material that is substantially opaque to visible light, yet at least partially transparent to non visible light, the binder being marked with laser light through the blocking layer.

8. The material of claim 1 wherein a laminate is applied over the binder, the binder being marked with laser light through the laminate.

9. The material of claim 1 wherein the binder comprises a coating.

10. The material of claim 1 wherein the coating is printed on the substrate.

11. The material of claim 10 wherein the coating is printed with an offset press.

12. The material of claim 10 wherein the coating is applied with a gravure press.

13. The material of claim 10 wherein the coating is applied with a screening process.

14. A method for marking indicia on a document, the method comprising:
applying a coating of pigment dispersed in a binder; and
laser engraving the coating.

15. The method of claim 14 including applying the coating to form a first indicia, and laser engraving the coating to form a second indicia within the first indicia.

16. The method of claim 15 wherein the first indicia comprised fixed information common to documents issued from an issuer, and the second indicia comprises personalized information of a bearer of the document.

17. The method of claim 15 wherein both the first and second indicia comprise personalized information of a bearer of the document.

18. The method of claim 14 comprising applying a laminate over the coating, and laser engraving the coating through the laminate.

19. The method of claim 14 comprising applying a blocking layer over the coating, and laser engraving the coating through the blocking layer, the blocking layer being substantially opaque to visible light.

20. The method of claim 14 wherein the laser marking forms a variable indicia depicting biometric information of a bearer of the document.

21. The method of claim 19 wherein the laser engraving forming a variable indicia of personal information of a bearer of the document.

22. The method of claim 21 wherein the variable indicia of personal information comprises biometric information of the bearer.

23. A method for authenticating a laser marked document, the laser marked document including a laser marked indicia in a carrier indicia, the method comprising:
illuminating the document with a light source in a band corresponding to optical property of a laser marked indicia in the document;
capturing one or more images of the document, including the laser marked indicia;
analyzing the laser marked indicia and the carrier indicia; and
providing a measure of validity based on the analyzing.

24. The method of claim 23 wherein the laser marked indicia comprises biometric information of a document bearer, and the analyzing includes comparing the biometric information from the laser marked indicia with biometric information elsewhere on the document.

25. The method of claim 23 wherein the carrier indicia comprises variable information related to a bearer of the document.
